(19) United States
(12) Patent Application Publication
(10) Pub. No.: US 2022/0152793 A1
(43) Pub. Date: May 19, 2022

(54) DRIVING TOOL

(71) Applicant: SHIFUKANG INDUSTRIAL.CO., LTD., TAICHUNG CITY (TW)

(72) Inventor: Shang-Yuan HUANG, Taichung City (TW)

(21) Appl. No.: 17/099,006

(22) Filed: Nov. 16, 2020

(51) Int. Cl. B25B 21/02; B25B 23/00

(52) U.S. Cl. CPC B25B 21/02; B25B 19/00; B25B 23/0028

(57) ABSTRACT

A driving tool is provided, including: a rod member, including a first end and a second end which includes two separate connection sections; a swingable assembly, including a swingable member having a third end and a fourth end, a shaft and a ring retainer, the third end extending to between the two connection sections, the fourth end including an assembling portion, the shaft being disposed through the two connection sections and the third end, a first end of the shaft being protrusive out from a first one of the two connection sections, the ring retainer being detachably mounted on the first end of the shaft and blocked by the first one of the two connection sections in an axial direction of the shaft; and at least one driving member, detachably assembled with the assembling portion.

### BACKGROUND OF THE INVENTION

### Field of the Invention

The present invention relates to a driving tool.

### Description of the Prior Art

Generally, a wrench or other driving tools are used to turn the fastener (such as screws, nuts or the like). The torque is proportional to the force arm or the applying force. Therefore, to obtain a larger torque, there needs a larger length of the wrench or striking of other auxiliary tools (such as a hammer). The driving tools disclosed in U.S. Pat. No. 6,748,833, U.S. Pat. No. 6,769,334 and U.S. Pat. No. 7,089,833 are such a type the above-mentioned driving tool.

However, the above-mentioned conventional driving tools have defects and are not easy to use. In U.S. Pat. No. 6,748,833, the handle 3 and the arm 7 are connected by the shaft 9 and can relatively rotate. The pivotal joint mechanism of the handle 3 and the arm 7 is simple and open, and the arm 7 often overswings due to shaking or unexpected collision, so that the key 11 of the rectangular body will impact and damage the handle 3.

In U.S. Pat. No. 6,769,334, the adjustable wrench 10 is hooked on the shaft 46 via the long slot 32 and swings relative to the drive handle 12. However, the opening 33 can limit the adjustable wrench 10 to rotate at one side for a small range, so. As a result, the adjustable wrench 10 can detaches from the drive handle 12 during operation.

In U.S. Pat. No. 7,089,833, the adaptor 8 and the lever 10 are arranged on the U-shaped member 6 in a co-rotating manner. The adaptor 8 can be assembled with the socket member 9, and an end portion of the lever 10 can be forced by the pneumatic hammer 15 through the adapter 13, driving the socket member 9 to rotate. The rod member 7 is for gripping of a user, to support and stabilize the driving tool, or apply a force to generate a torque that is opposite to the torque caused by the pneumatic hammer 15. Obviously, the device in U.S. Pat. No. 7,089,833 has many components, and the adapter 13 needs to be mounted to the lever 10, which is very inconvenient. Additionally, in order to accurately assemble the adapter 13 to the lever 10, it must be short in size. Furthermore, the solid column 14 is easy to lose, and it is inconvenient to use in a narrow space. In addition, the solid column 14 can easily move relative to the lever 10 during operation so that the force cannot be effectively and stably transferred, and thus the user needs to hold the impact tool 15 by one hand and hold the rod member 7 by the other hand, for stable operation, which is very inconvenient.

The present invention is, therefore, arisen to obviate or at least mitigate the above-mentioned disadvantages.

### SUMMARY OF THE INVENTION

The main object of the present invention is to provide a driving tool which is easy to be used in a narrow space, has stable connection of parts and broad use, and is capable of one-hand operation.

To achieve the above and other objects, a driving tool is provided, including: a rod member, including a first end and a second end opposite to the first end, the first end being configured to be connected with a power tool, the second end including two connection sections which are separate and arranged in parallel; a swingable assembly, including a swingable member, a shaft and a ring retainer, the swingable member including a third end and a fourth end opposite to the third end, the third end extending to between the two connection sections, the fourth end including an assembling portion, the shaft being disposed through the two connection sections and the third end, a first end of the shaft being protrusive out from a first one of the two connection sections, the ring retainer being detachably mounted on the first end of the shaft and blocked by the first one of the two connection sections in an axial direction of the shaft; and at least one driving member, detachably assembled with the assembling portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a drawing showing swinging of a driving tool of a preferable embodiment of the present invention;

FIG. 4 is a partial enlargement of a preferable embodiment of the present invention;

FIG. 5 is a partial enlargement of FIG. 4;

FIGS. 6 and 7 are drawings showing operation of a preferable embodiment of the present invention;

FIG. 8 is a drawing showing operation of another preferable embodiment of the present invention;

FIG. 9 is a partial cross-sectional view of FIG. 8; and

FIG. 10 is a side view of another preferable embodiment of the present invention.

### DETAILED DESCRIPTION OF THE PREFERRED EMBODIMENTS

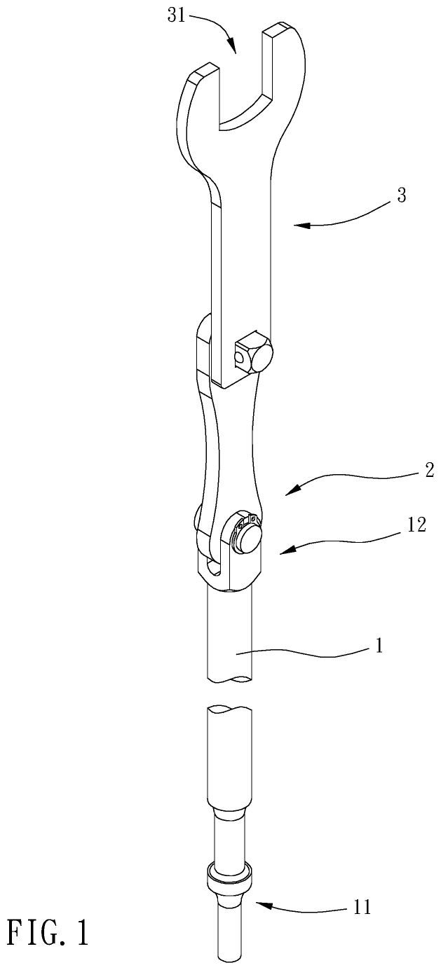

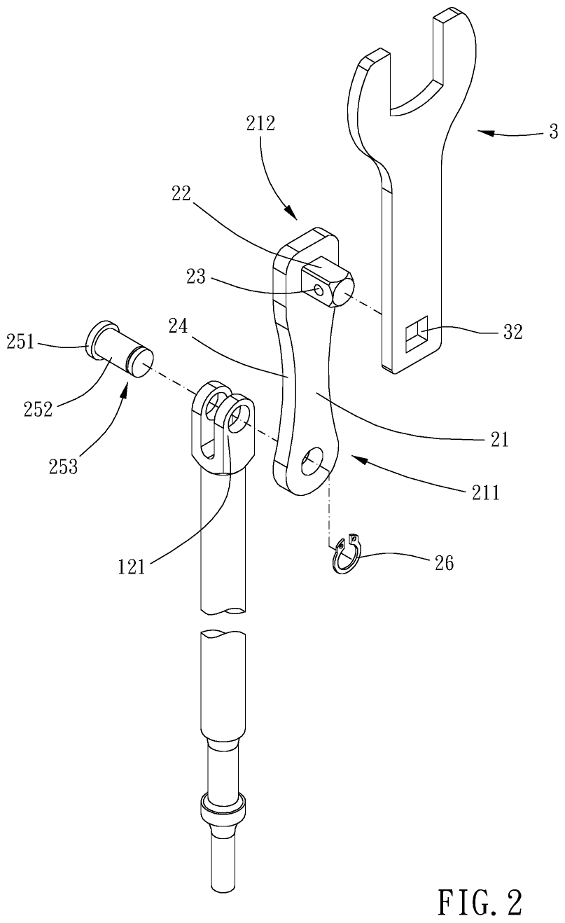

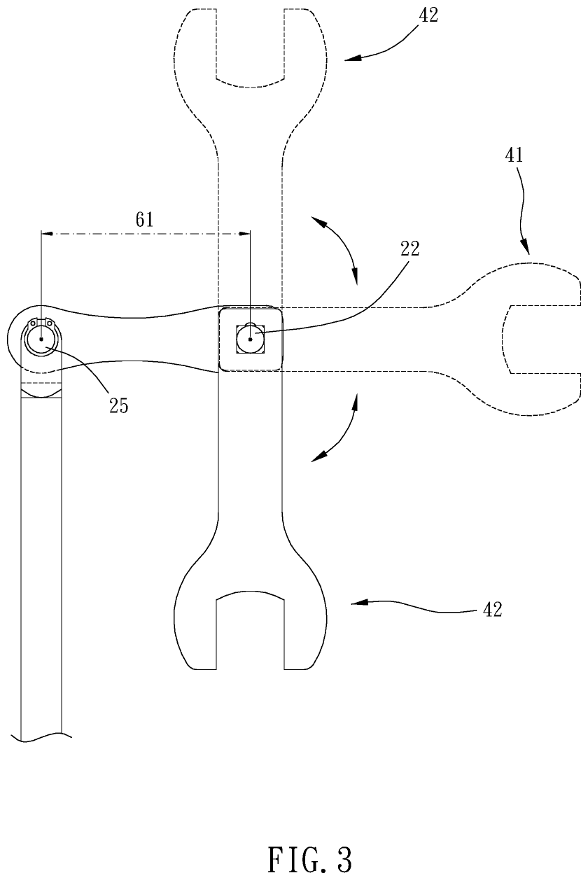

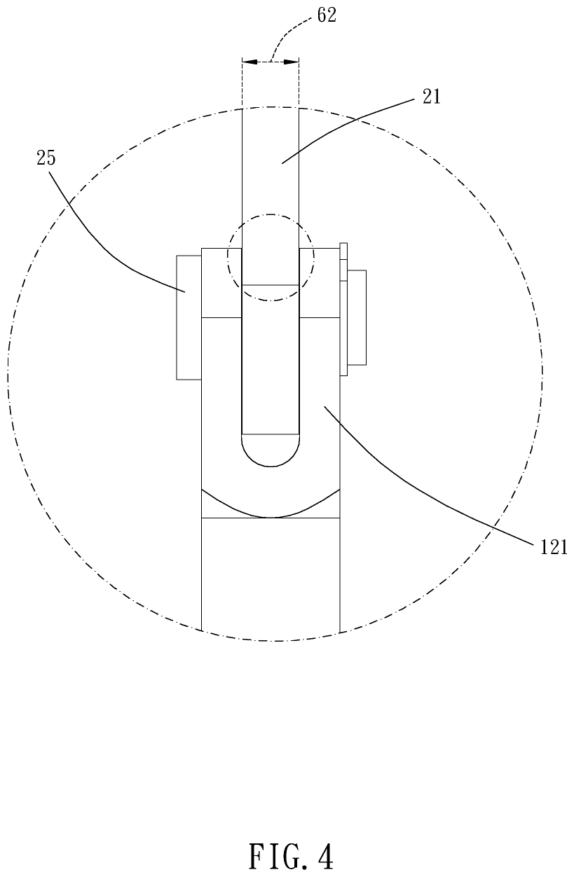

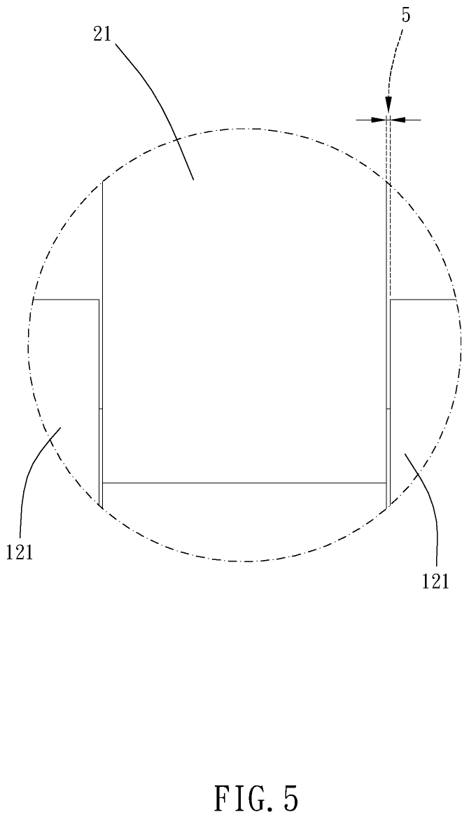

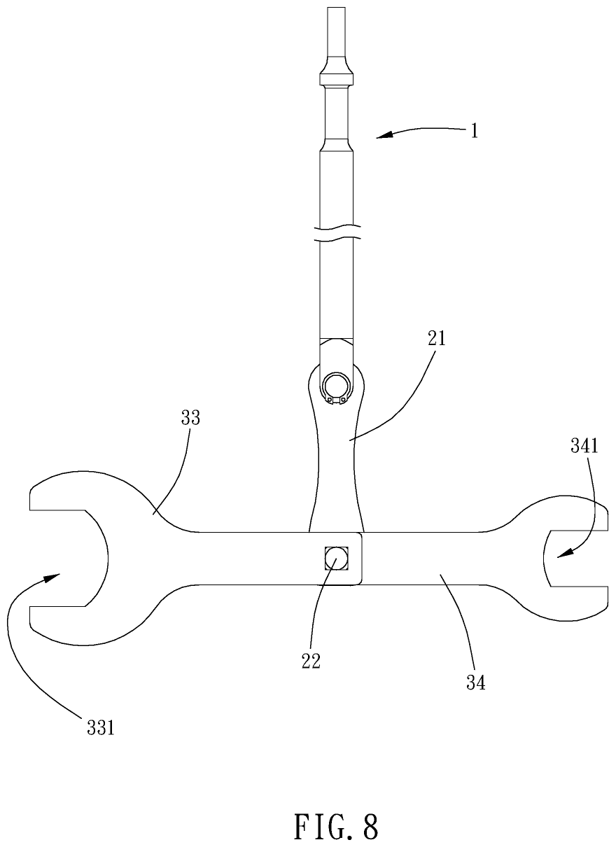

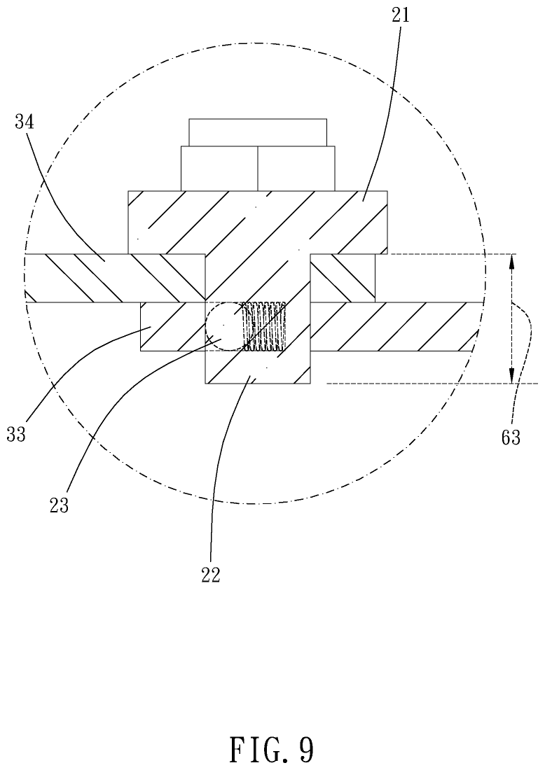

Please refer to FIGS. 1 to 9 for a preferable embodiment of the present invention. A driving tool of the present invention includes a rod member 1, a swingable assembly 2 and at least one driving member 3.

The rod member 1 includes a first end 11 and a second end 12 opposite to the first end 11, and the first end 11 is connected with a power tool. For example, the first end 11 includes a connection head configured to be connected to a pneumatic tool. The second end 12 includes two connection sections 121 which are separate and arranged in parallel. The swingable assembly 2 includes a swingable member 21, a shaft 25 and a ring retainer 26. The swingable member 21 includes a third end 211 and a fourth end 212 opposite to the third end 211, the third end 211 extends to between the two connection sections 121, and the fourth end 212 includes an assembling portion 22. The shaft 25 is disposed through the two connection sections 121 and the third end 211, and a first end of the shaft 25 is protrusive out from a first one of the two connection sections 121. The ring retainer 26 detachably is detachably mounted on the first end of the shaft 25 the shaft 25 and blocked by the first one of and the connection section 121. The at least one driving member 3 is detachably assembled with the assembling portion 22 and configured to rotate a fastener 7.

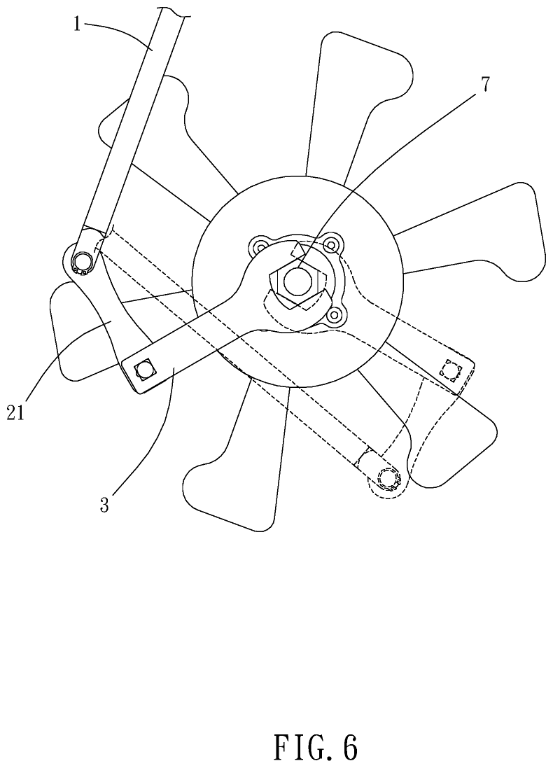

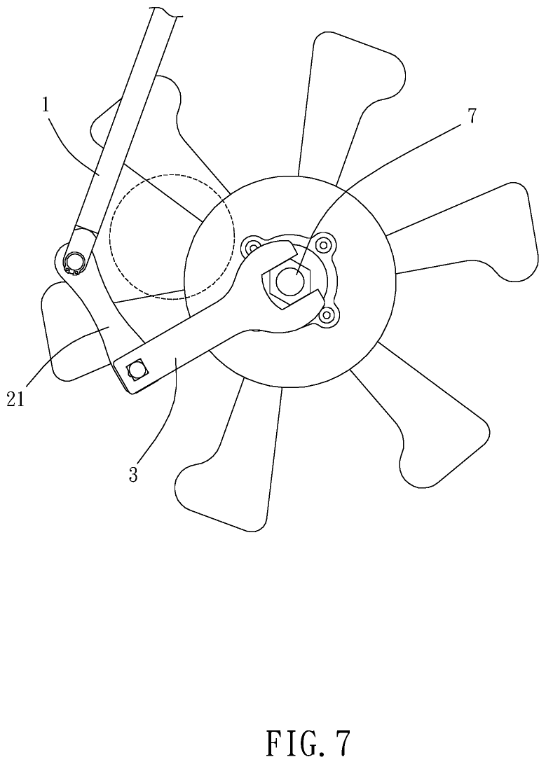

By using the swingable assembly 2, the driving tool is more flexible and has less limitation in operation, and the rod member 1 can be adjusted to be at proper angle to operate and avoid obstacles. For example, as shown in FIG. 6, the at least one driving member 3 is rotatable about the fastener 7; or, as shown in FIG. 7, the at least one driving member 3 and the swingable member 21 can be angularly arranged with a specific included angle therebetween so as to avoid the obstacle (the circle shown in dash line), which can rotate the fastener 7.

The third end 211 is interposed between the two connection sections 121 so that the swingable member 21 can be stably support. The shaft 25 is mounted with the ring retainer 26 so that the swingable member 21 can be effectively connected with the rod member 1, which prevents the swingable member 21 from detachment during operation. It is noted that the ring retainer 26 may be detachable, which allows replacement of the swingable member.

Preferably, the rod member 1 has a length at least three times a length of the swingable member 21, for operation in a narrow space such as a car engine room.

A position where the swingable member 21 is arranged in line with the rod member 1 is defined as a first position 41, the swingable member 21 is swingable from the first position 41 to an extreme position 42 where the swingable member 21 is located at a side of the rod member 1, and a swinging angle of the swingable member 21 from the first position 41 to the extreme position 42 is between 90 degrees to 92 degrees.

The swingable member 21 is plate-shaped, thus facilitating inserting through a narrow gap. The third end 211 is disposed between the two connection sections 121, and between the third end 211 and each of the two connection sections 121 is a gap 5 between 0.05 mm to 0.15 mm, for providing sufficient stability and flexibility.

The third end 211 and the fourth end 212 are located on a longitudinal direction of the swingable member 21, the swingable member 21 includes two concave portions 24, respectively, on a widthwise direction of the swingable member 21, and the two concave portions 24 are configured for hand gripping.

In this embodiment, a distance between centers of the shaft 25 and the assembling portion 22 is defined as a first dimension 61, and a height of the swingable member 21 is defined as a second dimension 62. A ratio of the second dimension 62 and the first dimension 61 is between 0.07 and 0.12, which can provide sufficient length and height of the swingable member 21 so as to obtain sufficient structural strength and force aim.

The shaft 25 includes an enlarged portion 251, a main body 252 and a distal end portion 253 which are connected in sequence, the main body 252 is disposed between the two connection sections 121, and the swingable member 21 is rotatable about the main body 252. In the axial direction of the shaft 25, the enlarged portion 251 is abutted against a first one of the two connection sections 121, the distal end portion 253 is axially protrusive beyond a second one of the two connection sections 121, and the ring retainer 26 is hooped on the distal end portion 253 and abutted against the second one of the two connection sections 121.

The at least one driving member 3 includes a jaw opening 31 and a connection portion 32, the jaw opening 31 is configured to receive the fastener 7, and the connection portion 32 is configured to be detachably connected to and swingable with the assembling portion 22. One of the connection portion 32 and the assembling portion 22 includes a projection which is non-circular, and the other of the connection portion 32 and the assembling portion 22 includes a hole which is non-circular. For example, the assembling portion 22 includes the projection. Through connection of the projection and the hole, it is easy to assemble/disassemble, and avoid unexpected detachment and relative rotation.

Preferably, the hole is a through hole so that the assembling can be carried out from any sides.

In this embodiment, the assembling portion 22 and the ring retainer 26 are located at a same side of the driving tool, the assembling portion 22 is a square post, and the connection portion 32 is a square hole; and a height of the assembling portion 22 is defined as a third dimension 63. The third dimension 63 is at least two times the second dimension 62, and the height of the at least one driving member 3 is less than the second dimension 62, so that the assembling portion 22 can be assembled in various ways.

Specifically, the at least one driving member includes a plurality of driving members 3, the plurality of driving members 3 include a first driving member 33 and a second driving member 34, and a detent ball member 23 is disposed on and radially protrusive from the assembling portion 22. As the connection portion 32 of the first driving member 33 is sleeved to the assembling portion 22 in an axial direction of the assembling portion 22, as viewed in the axial direction of the assembling portion 22, at least part of the detent ball member 23 is radially protrusive beyond the connection portion 32 of the first driving member 33.

In this embodiment, as the connection portion 32 of the first driving member 33 is sleeved to the assembling portion 22, the first driving member 33 is abutted between the detent ball member 23 and the swingable member 21 so that the first driving member 33 is stably held. Besides, the assembling portion 22 can be further assembled with the second driving member 34. As the second driving member 34 is sleeved to the assembling portion 22, the connection portion 32 of the second driving member 34 is blocked by the at least part of the detent ball member 23. As a result, the first driving member 33 and the second driving member 34 can be assembled to the assembling portion 22 at once time. For example, the jaw opening 331 of the first driving member 33 is smaller than the jaw opening 341 of the first driving member 33, so it is optional to choose the first driving member 33 or the second driving member 34 to operate without replacing.

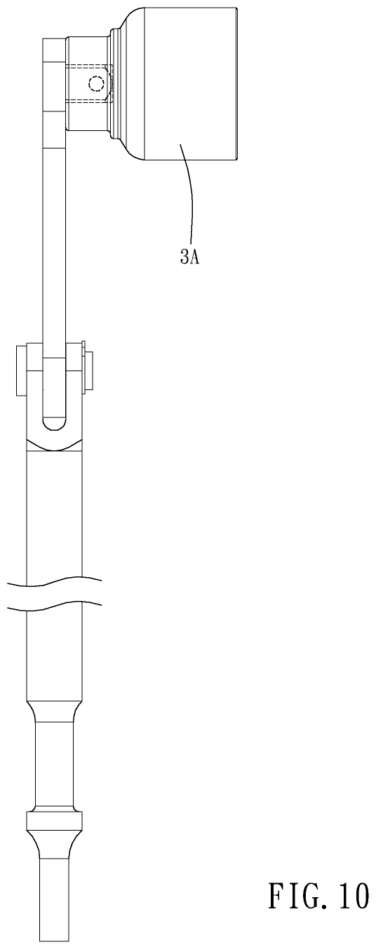

It is noted that the configuration and type of the driving member 3 should not be limited to that described above. In an alternative embodiment as shown in FIG. 10, there is only one single driving member 3A, and the driving member 3A is a socket member.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A driving tool, including:
a rod member, including a first end and a second end opposite to the first end, the first end being configured to be connected with a power tool, the second end including two connection sections which are separate and arranged in parallel;
a swingable assembly, including a swingable member, a shaft and a ring retainer, the swingable member including a third end and a fourth end opposite to the third end, the third end extending to between the two connection sections, the fourth end including an assembling portion, the shaft being disposed through the two connection sections and the third end, a first end of the shaft being protrusive out from a first one of the two connection sections, the ring retainer being detachably mounted on the first end of the shaft and blocked by the first one of the two connection sections in an axial direction of the shaft; and
at least one driving member, detachably assembled with the assembling portion.

2. The driving tool of claim 1, wherein a position where the swingable member is arranged in line with the rod member is defined as a first position, the swingable member is swingable from the first position to an extreme position where the swingable member is located at a side of the rod member, and a swinging angle of the swingable member from the first position to the extreme position is between 90 degrees to 92 degrees.

3. The driving tool of claim 1, wherein the at least one driving member includes a socket member.

4. The driving tool of claim 1, wherein the at least one driving member includes a jaw opening and a connection portion, the jaw opening is configured to receive a fastener, the connection portion is configured to be detachably connected to and swingable with the assembling portion, one of the connection portion and the assembling portion includes a projection which is non-circular, and the other of the connection portion and the assembling portion includes a hole which is non-circular.

5. The driving tool of claim 4, wherein the at least one driving member includes a plurality of driving members, the plurality of driving members include a first driving member and a second driving member, the assembling portion includes the projection, a detent ball member is disposed on and radially protrusive from the assembling portion, as the connection portion of the first driving member is sleeved to the assembling portion in an axial direction of the assembling portion, as viewed in the axial direction of the assembling portion, at least part of the detent ball member is radially protrusive beyond the connection portion of the first driving member, and as the second driving member is sleeved to the assembling portion, the connection portion of the second driving member is blocked by the at least part of the detent ball member.

6. The driving tool of claim 5, wherein as the connection portion of the first driving member is sleeved to the assembling portion, the first driving member is abutted between the detent ball member and the swingable member.

7. The driving tool of claim 4, wherein the assembling portion includes the projection, and the assembling portion and the ring retainer are located at a same side of the driving tool.

8. The driving tool of claim 1, wherein the third end and the fourth end are located on a longitudinal direction of the swingable member, the swingable member includes two concave portions on two lateral sides, respectively, on a widthwise direction of the swingable member, and the two concave portions are configured for hand gripping.

9. The driving tool of claim 1, wherein the swingable member is plate-shaped, and the third end is disposed between the two connection sections, and between the third end and each of the two connection sections is a gap between 0.05 mm to 0.15 mm.

10. The driving tool of claim 6, wherein a position where the swingable member is arranged in line with the rod member is defined as a first position, the swingable member is swingable from the first position to an extreme position where the swingable member is located at a side of the rod member, and a swinging angle of the swingable member from the first position to the extreme position is between 90 degrees to 92 degrees; the at least one driving member includes a socket member; the assembling portion includes the projection, the assembling portion and the ring retainer are located at a same side of the driving tool; the third end and the fourth end are located on a longitudinal direction of the swingable member, the swingable member, the swingable member includes two concave portions on two lateral sides, respectively, on a widthwise direction of the swingable member, and the two concave portions are configured for hand gripping;
the swingable member is plate-shaped, and the third end is disposed between the two connection sections, between the third end and each of the two connection sections is a gap between 0.05 mm to 0.15 mm; the rod member has a length at least three times a length of the swingable member; the assembling portion is a square post, the connection portion is a square hole; a distance between centers of the shaft and the assembling portion is defined as a first dimension, a height of the swingable member is defined as a second dimension, a ratio of the second dimension and the first dimension is between 0.07 and 0.12; a height of the assembling portion is defined as a third dimension, the third dimension is at least two times the second dimension; the first end includes a connection head configured to be connected to a pneumatic tool; the shaft includes an enlarged portion, a main body and a distal end portion which are connected in sequence, the main body is disposed between the two connection sections, the swingable member is rotatable about the main body, in the axial direction of the shaft, the enlarged portion is abutted against a first one of the two connection sections, the distal end portion is axially protrusive beyond a second one of the two connection sections, the ring retainer is hooped on the distal end portion and abutted against the second one of the two connection sections; the hole is a through hole.
